(19) United States
(12) Patent Application Publication
(10) Pub. No.: US 2018/0243942 A1
(43) Pub. Date: Aug. 30, 2018

(54) MANUFACTURING METHOD OF CERAMIC BODY

(71) Applicant: NGK INSULATORS, LTD., Nagoya-City (JP)

(72) Inventor: Daniel Yukichi Kitaguchi, Nagoya-City (JP)

(73) Assignee: NGK INSULATORS, LTD., Nagoya-City (JP)

(21) Appl. No.: 15/855,044

(22) Filed: Dec. 27, 2017

(30) Foreign Application Priority Data
Feb. 24, 2017 (JP) 2017-033973

(51) Int. Cl. B28B 11/24; F27B 9/24

(52) U.S. Cl. CPC B28B 11/243; F27B 9/2407

(57) ABSTRACT

A manufacturing method of a ceramic body which includes a firing step of firing a ceramic formed body in a firing kiln,
wherein in the firing step, a temperature rise process until reaching a firing temperature of the ceramic formed body is divided into a plurality of temperature regions including a first temperature region, a second temperature region, and a third temperature region,
the manufacturing method of the ceramic body further including an oxygen concentration adjustment step of adjusting a first oxygen concentration in the first temperature region in a range of 7 to 21 vol %, a maximum value of a second oxygen concentration in the second temperature region in a range of 3 to 11 vol %, and a maximum value of a third oxygen concentration in the third temperature region in a range of 3 to 11 vol %.

### BACKGROUND OF THE INVENTION

### Field of the Invention

The present invention relates to a manufacturing method of a ceramic body, and more particularly, it relates to a manufacturing method of a ceramic body to inhibit generation of cracks (firing cuts) in a firing step during manufacturing of the ceramic body of a honeycomb structure or the like.

### Description of the Related Art

Heretofore, ceramic bodies have been utilized in various industrial technology fields, and for example, a ceramic honeycomb structure that is one type of ceramic body has been used in a broad use application to a car exhaust gas purifying catalyst carrier, a diesel particulate removing filter, a gasoline particulate removing filter, a heat reservoir for a burning device, or the like. The honeycomb structure made of ceramic (hereinafter referred to simply as “the honeycomb structure”) is manufactured through steps of extruding a forming material (a kneaded material) prepared at a predetermined blend ratio into a desirable honeycomb form by use of an extruder and raw-cutting, drying and finish-cutting an obtained honeycomb formed body (a ceramic formed body) and then through a firing step of firing the honeycomb formed body at a high temperature. It is to be noted that when necessary, a plugged honeycomb structure is occasionally manufactured in which a plurality of plugging portions are provided to plug open ends of cells of end faces of the honeycomb structure in accordance with a predetermined arrangement standard.

In the above firing step, the honeycomb formed body having one end face directed downward is mounted on a shelf plate and is thrown into a firing kiln together with the shelf plate. Here, as the firing kiln, a continuous firing kiln (a tunnel kiln) in which a kiln space extends along a longitudinal direction is mainly used, the kiln space between an inlet and an outlet is adjusted at a predetermined kiln temperature, and the honeycomb formed body is conveyed along a horizontal direction in the kiln space, thereby firing the honeycomb formed body (e.g., see Patent Documents 1 to 4).

At this time, the kiln space is set so that a temperature rises gradually from the inlet at a prescribed temperature rise rate to reach a high firing temperature. For example, in the honeycomb structure including cordierite as a main component, the firing temperature is set in a range of 1200° C. to 1500° C. Specifically, there are adjusted time for which a temperature in the vicinity of room temperature at the inlet reaches the firing temperature at 1200° C. or higher, a conveyance speed of the shelf plate, a conveyance distance, and the like. On the other hand, after completion of the firing at the high firing temperature, the kiln temperature is gradually lowered, thereby cooling the fired honeycomb structure down to a temperature at which the honeycomb structure can be taken out from the outlet.

Here, when oxide-based ceramic including cordierite that is the main component as described above is used as the forming material (the kneaded material), the kiln space is adjusted under air atmosphere. On the other hand, when non-oxide ceramic such as silicon carbide is used, the kiln space is adjusted under an inert gas atmosphere replaced with an inert gas such as an argon gas, for the purpose of preventing oxidation. Here, in the present description, description is especially made as to a manufacturing method of a ceramic body in which firing is performed under the air atmosphere including oxygen. Hereinafter, description will be made as to a honeycomb formed body in the form of a honeycomb which is an example of a ceramic formed body and a honeycomb structure that is an example of the ceramic body, unless otherwise specified.

[Patent Document 1] JP-T-2001-524450

[Patent Document 2] JP-T-2001-524451

[Patent Document 3] JP-T-2001-525531

[Patent Document 4] JP-T-2001-527202

### SUMMARY OF THE INVENTION

However, in the case of firing a honeycomb formed body under air atmosphere including oxygen, there is the possibility that after-mentioned disadvantages occur. Specifically, a forming material (a kneaded material) constituting the honeycomb formed body includes various components such as a pore former and an organic binder. Therefore, in a temperature rise process in which a temperature of the honeycomb formed body rises up to a high firing temperature, a part of the forming material decomposes to cause an exothermic reaction, or burns due to a combustible material, or a plurality of organic substances included in the honeycomb formed body and a carbon residue content derived from the organic substances occasionally simultaneously burn.

Consequently, the temperature of the honeycomb formed body which is rising might rapidly rise. In particular, a temperature of an inner portion (a central portion) of the formed body in which heat is easily accumulated (from which the heat is not easily radiated) might rapidly rise. As a result, a difference between a temperature of the surface of the honeycomb formed body and the temperature of the inner portion of the formed body is made, thereby increasing the possibility that cracks (firing cuts) are generated in a fired honeycomb structure. Especially, when the honeycomb structure or the like for a gasoline particulate filter (GPF), i.e., a particulate removing filter for a gasoline car has a high porosity and includes 2.5% or more of a pore former, it is known that a rapid exothermic peak derived from the organic substances of the organic binder and the like (the combustible material) is observed in the vicinity of about 200° C., and it is known that a rapid exothermic peak derived from unburnt soot (the carbon residue content) of the pore former or the like is observed in the vicinity of about 300° C. Furthermore, it is known that when the exothermic peak derived from the organic substances of the organic binder and the like (the combustible material) is superimposed on the exothermic peak derived from the unburnt soot of the pore former or the like (the carbon residue content), a further larger exothermic peak is observed.

There is known a technology to control and inhibit the generation of the cracks due to the temperature difference in the temperature rise process. Specifically, there is adjusted a temperature rise rate or a conveyance distance until the firing temperature is reached, so that it is possible to suppress the rapid exothermic peak to a certain degree. Additionally, there is known a technology of introducing a gas abundantly including carbon dioxide into a firing atmosphere or introducing a low oxygen gas which does not include fluorine into the firing atmosphere in a firing step, to enable stable production of a ceramic honeycomb structure in which there are not any cracks (e.g., see Patent Documents 1 to 4 described above).

However, when the temperature rise rate, the conveyance distance or the like in a kiln space is adjusted, a conveyance speed of the honeycomb formed body drops, or the conveyance distance in the kiln space until reaching the firing temperature lengthens, and there is the possibility that the firing step is longer than before. As a result, the productivity of the honeycomb structure deteriorates, and furthermore, there is also the fear that manufacturing cost increases due to the deterioration of the productivity.

As a result of intensive studies to solve the above problems, the present applicant has found that in the temperature rise process in which the temperature in the vicinity of room temperature reaches the high firing temperature, a concentration of oxygen in the kiln space is appropriately controlled, thereby inhibiting generation of the rapid exothermic peak due to the burning of the combustible material of the organic binder or the like or generation of the rapid exothermic peak due to the burning of the unburnt soot (the carbon residue content) of the pore former or the like, in a specific temperature range. Consequently, there are expected the effect of inhibiting the generation of the cracks in the temperature rise process and the effect of inhibiting deterioration of a manufacturing efficiency or the increase of the manufacturing cost.

Thus, the present invention has been developed in view of the above actual circumstances, and an object thereof is to provide a manufacturing method of a ceramic body in which in a firing step to manufacture the ceramic body of a honeycomb structure or the like, a concentration of oxygen in a kiln space of a firing kiln is appropriately controlled to inhibit generation of cracks.

According to the present invention, there is provided a manufacturing method of a ceramic body which solves the above problems.

[1] A manufacturing method of a ceramic body which includes a firing step of firing a ceramic formed body in a firing kiln, wherein in the firing step, a temperature rise process until reaching a firing temperature of the ceramic formed body is divided into a plurality of temperature regions including a first temperature region including a temperature rise start point, a second temperature region having a higher temperature than the first temperature region, and a third temperature region having a higher temperature than the second temperature region, and the manufacturing method of the ceramic body further includes an oxygen concentration adjustment step of adjusting a first oxygen concentration in the first temperature region in a range of 7 to 21 vol %, adjusting a maximum value of a second oxygen concentration in the second temperature region in a range of 3 to 11 vol % which is smaller than a maximum value of the first oxygen concentration, and adjusting a maximum value of a third oxygen concentration in the third temperature region in a range of 3 to 11 vol % which is smaller than the maximum value of the first oxygen concentration.

[2] The manufacturing method of the ceramic body according to the above [1], wherein as the firing kiln, a continuous firing kiln is used which has an inlet and an outlet and is configured to fire the ceramic formed body while conveying the ceramic formed body in a kiln space between the inlet and the outlet, the first temperature region includes the inlet as the temperature rise start point, the second temperature region is positioned on a downstream side of the conveyance of the ceramic formed body from the first temperature region, and the third temperature region is positioned on the downstream side of the conveyance of the ceramic formed body from the second temperature region.

[3] The manufacturing method of the ceramic body according to the above [1] or [2], wherein in the oxygen concentration adjustment step, a minimum value of the first oxygen concentration is adjusted to 8 vol % or more and the maximum value of the second oxygen concentration is adjusted to 8 vol % or less.

[4] The manufacturing method of the ceramic body according to any one of the above [1] to [3], wherein in the oxygen concentration adjustment step, the maximum value of the third oxygen concentration is adjusted in a range of 6 to 10 vol %.

[5] The manufacturing method of the ceramic body according to any one of the above [1] to [4], wherein an upper limit value of the first temperature region is adjusted to a temperature range of 250° C.±50° C.

[6] The manufacturing method of the ceramic body according to any one of the above [1] to [5], wherein in the oxygen concentration adjustment step, the maximum value of the third oxygen concentration in the third temperature region is adjusted to be smaller than the maximum value of the second oxygen concentration, and a lower limit value of the third temperature region is adjusted to a temperature range of 400° C.±50° C.

[7] The manufacturing method of the ceramic body according to any one of the above [1] to [5], wherein in the oxygen concentration adjustment step, the maximum value of the third oxygen concentration in the third temperature region is adjusted to be larger than the maximum value of the second oxygen concentration, and a lower limit value of the third temperature region is adjusted to a temperature range of 400° C.±50° C.

[8] The manufacturing method of the ceramic body according to any one of the above [1] to [7], wherein in the oxygen concentration adjustment step, the first oxygen concentration is adjusted to gradually or stepwisely lower, as the process is close to the second temperature region.

[9] The manufacturing method of the ceramic body according to any one of the above [1] to [8], wherein the ceramic body is a honeycomb structure.

According to a manufacturing method of a ceramic body of the present invention, a temperature rise process until reaching a firing temperature is divided into at least three temperature regions, and an oxygen concentration in each temperature region is adjusted, so that it is possible to inhibit a rapid temperature rise of a ceramic formed body in a firing step and it is also possible to inhibit generation of cracks.

### BRIEF DESCRIPTION OF THE DRAWINGS

FIG. 1 is an explanatory view schematically showing a firing kiln for use in a manufacturing method of a ceramic body of one embodiment of the present invention, and an example where a temperature rise process is divided into a plurality of temperature regions;

FIG. 2 is a graph showing a correlation between elapsed time in the temperature rise process and an internal temperature of a honeycomb formed body in the manufacturing method of the ceramic body of the one embodiment of the present invention; and

FIG. 3 is a graph showing a correlation of the elapsed time in FIG. 2 with a difference (ΔT) between the internal temperature of the honeycomb formed body and a kiln temperature.

### DESCRIPTION OF THE PREFERRED EMBODIMENTS

Hereinafter, description will be made as to an embodiment of a manufacturing method of a ceramic body of the present invention in detail with reference to the drawings. It is to be noted that the manufacturing method of the ceramic body of the present invention is not limited to the following embodiment, and various design changes, modifications, improvements and the like are addable without departing from the gist of the present invention.

A manufacturing method of a honeycomb structure (corresponding to the manufacturing method of the ceramic body) in one embodiment of the present invention mainly includes a forming step of extruding a forming material (a kneaded material) prepared at a predetermined blend ratio to form a honeycomb formed body 10 having partition walls (not shown) defining a plurality of cells (not shown) forming through channels for a fluid and extending from one end face 11a to the other end face 11b, a plugging portion forming step of plugging open ends of the respective cells (not shown) on the sides of the one end face 11a and the other end face 11b of the honeycomb formed body 10 in accordance with a predetermined arrangement standard, a mounting step of mounting the honeycomb formed body 10, in which plugging portions are formed in the plugging portion forming step, on a shelf plate 12 in a state where the side of the other end face 11b is directed downward, a conveyance step of conveying the honeycomb formed body 10 mounted on the shelf plate 12 from an inlet 21 of a firing kiln 20 toward an outlet 22 thereof, and a firing step of firing the honeycomb formed body 10 conveyed through a kiln space 23 of the firing kiln 20 in the conveyance step, at a predetermined firing temperature. It has been described above that the plugging portions are formed in the honeycomb formed body 10, and then the honeycomb formed body is fired at the high temperature, but the present invention is not limited to this example, and the plugging portion forming step of forming the plugging portions may be performed after the firing step is performed.

Here, the forming step, the plugging portion forming step, the mounting step and the conveyance step are well known in a conventional manufacturing method of a honeycomb structure, and hence detailed descriptions thereof are omitted. Furthermore, “a honeycomb structure 26” obtainable by firing the honeycomb formed body 10 corresponds to the ceramic body in the present invention.

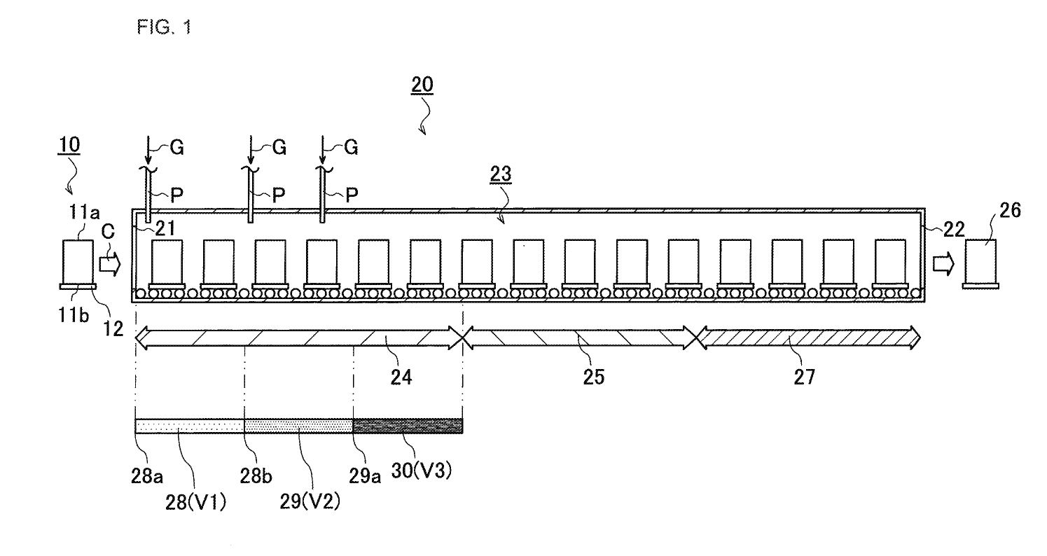

As schematically shown in FIG. 1, as the firing kiln 20 for use in the firing step, there is usable a so-called “tunnel kiln”, “a roller hearth kiln”, or the like possessing a hollow tunnel structure and having the inlet 21 on one end side and the outlet 22 on the other end side. Here, a space surrounded by a kiln wall made of a fire-resistant material and extending from the inlet 21 to the outlet 22 is “the kiln space 23”. It is to be noted that the description will be made below as to the manufacturing method of the ceramic body of the present embodiment by use of the firing kiln 20 (a so-called “continuous firing kiln”) which includes the inlet 21 and the outlet 22 as described above and is configured to fire the honeycomb formed body 10 while conveying the honeycomb formed body, but the present invention is not limited to this example. That is, there may be used a firing kiln having a structure of “a shuttle kiln” in which the same port serves as the inlet and the outlet. In this case, the conveyance step (conveyance means) of conveying the honeycomb formed body thrown into the firing kiln along with a horizontal direction to a predetermined place is not required. Furthermore, there are not any special restrictions on the firing kiln as long as the firing kiln has a mechanism in which an oxygen concentration in the kiln space of the firing kiln is optionally adjustable in a temperature rise process until a temperature in the vicinity of room temperature reaches the firing temperature.

According to the manufacturing method of the ceramic body of the present embodiment, by use of the well-known conveyance means disposed in the kiln space 23 of the firing kiln 20, the honeycomb formed body 10 mounted on the shelf plate 12 is conveyed from the inlet 21 to the outlet 22 along a conveyance direction C matching a horizontal direction at a constant conveyance speed. Here, in the present embodiment, to simplify the drawing, the inlet 21 and the outlet 22 are arranged on one straight line, and the longitudinal kiln space 23 is shown, but the present invention is not limited to this example, and a conveyance path may optionally be changed.

The kiln space 23 of the firing kiln 20 from the inlet 21 on the one end side to the outlet 22 on the other end side is divided into a plurality of sections. That is, the kiln space includes a section (a temperature rise section 24) in which a temperature rises from the inlet 21 until reaching the firing temperature to fire the honeycomb formed body 10, a section (a firing section 25) positioned on a downstream side of the temperature rise section 24 to maintain the constant firing temperature, thereby firing the honeycomb formed body 10, and a section (a cooling section 27) to gradually cool the fired honeycomb structure 26 down to a temperature at which the honeycomb structure can be taken out from the outlet 22 (see FIG. 1). Here, the temperature rise section 24 corresponds to “the temperature rise process” in the present invention in which a kiln temperature is raised from the vicinity of room temperature until reaching the firing temperature. Respective section lengths of the temperature rise section 24, the firing section 25 and the cooling section 27 are optionally changeable in accordance with a conveyance speed of the honeycomb formed body 10, the firing temperature, components of the forming material constituting the honeycomb formed body 10 that is a firing target, or the like.

Furthermore, in the manufacturing method of the honeycomb structure of the present embodiment, the temperature rise process corresponding to the temperature rise section 24 is further dividable into a plurality of regions. Specifically, the regions include at least a first temperature region 28 in which the inlet 21 is defined as a temperature rise start point 28a, a second temperature region 29 positioned on a downstream side of conveyance of the honeycomb formed body 10 from the first temperature region 28, connected to an end point 28b of the first temperature region 28 and having a higher temperature than the first temperature region 28, and a third temperature region 30 positioned on the downstream side of the conveyance of the honeycomb formed body 10 from the second temperature region 29, connected to an end point 29a of the second temperature region 29 and having a higher temperature than the second temperature region 29 (see FIG. 1). Here, the third temperature region 30 is connected to the firing section 25.

Here, the manufacturing method of the honeycomb structure of the present embodiment further includes an oxygen concentration adjustment step of adjusting an oxygen concentration (a first oxygen concentration V1) of the kiln space 23 in the first temperature region 28, an oxygen concentration (a second oxygen concentration V2) of the kiln space 23 in the second temperature region 29, and an oxygen concentration (a third oxygen concentration V3) of the kiln space 23 in the third temperature region 30. It is to be noted that the second temperature region 29 does not necessarily have to be connected to the end point 28b of the first temperature region 28, and the end point 28b may be away from a start point (not shown) of the second temperature region 29. Similarly, the third temperature region 30 does not necessarily have to be connected to the end point 29a of the second temperature region 29, and the endpoint 29a may be away from a start point (not shown) of the third temperature region 30.

A specific adjustment method of the respective oxygen concentrations V1, V2 and V3 in the oxygen concentration adjustment step can be performed, for example, by providing a plurality of gas supply pipes P communicating with the respective temperature regions 28, 29 and 30, respectively, in the temperature rise section 24 of the kiln space 23, and supplying an adjusting gas G from the gas supply pipes P to change the oxygen concentrations V1, V2 and V3 of the respective temperature regions 28, 29 and 30. Here, the kiln space 23 is opened to the outside (the atmospheric air), and hence when the adjusting gas G is not supplied or when the atmospheric air is used as the adjusting gas G, the respective temperature regions 28, 29 and 30 of the kiln space 23 has the same oxygen concentration (about 21 vol %) as under the atmospheric air.

Furthermore, in the manufacturing method of the honeycomb structure of the present embodiment, in the kiln space 23 of the firing kiln 20, the temperature rise section 24 until reaching the firing temperature is divided into a plurality of temperature regions 28, 29 and 30, and the oxygen concentrations V1, V2 and V3 in the respective temperature regions 28, 29 and 30 are optionally adjustable. It is to be noted that the number of the temperature region 28 and others in the temperature rise section 24 is not limited to three, and the temperature rise section may have at least two regions 28 and 29, or may be divided into at least four temperature regions.

Consequently, during the firing of the honeycomb formed body 10, the honeycomb formed body 10 thrown from the inlet 21 in the vicinity of room temperature performs its temperature rise while passing through the respective regions having different oxygen concentrations in the temperature rise process until reaching a predetermined firing temperature (e.g., 1400° C. or the like).

The adjustment of the oxygen concentrations V1, V2 and V3 of the respective regions 28, 29 and 30 in the temperature rise process will be described. The first oxygen concentration V1 of the first temperature region 28 is adjustable in a range of 7 to 21 vol % (the oxygen concentration under the atmospheric air), and a maximum value of the second oxygen concentration V2 of the second temperature region 29 is further adjustable in a range of 3 to 11 vol % which is smaller than a maximum value of the set first oxygen concentration V1 (V1>V2). It is to be noted that a minimum value of the first oxygen concentration is adjustable to 8 vol % or more and the maximum value of the second oxygen concentration is adjustable to 8 vol % or less.

Further specifically, for example, the first oxygen concentration V1 may be adjusted to the oxygen concentration (21 vol %) under the atmospheric air, and the maximum value of the second oxygen concentration V2 may be set to be smaller (3 vol %, 8 vol %, 11 vol % or the like). Consequently, in the first temperature region 28 where the inlet 21 is defined as the temperature rise start point 28a and the temperature is comparatively low, the temperature rise is performed at the oxygen concentration (the first oxygen concentration V1) similar to a usual oxygen concentration under the atmospheric air, and in the second temperature region 29 where the temperature is slightly high, the oxygen concentration is set to the second oxygen concentration V2 which is lower than the oxygen concentration under the atmospheric air, and the temperature rises up to the firing temperature.

As a result, an exothermic reaction or a burning reaction of organic substances of an organic binder and the like included in the forming material constituting the honeycomb formed body 10 is caused in the first temperature region, and a stage to cause an exothermic reaction or a burning reaction of unburnt soot (a carbon residue content) of a pore former or the like can be included in the second temperature region 29. In a state where the oxygen concentration of the kiln space 23 is low, there is caused the exothermic reaction of the unburnt soot (the carbon residue content) of the pore former or the like, the exothermic reaction concerned with the burning reaction, or the like. Consequently, oxygen is less than usual under the atmospheric air, and hence the exothermic reaction becomes moderate, or the organic binder, the pore former or the like does not burn at once. As a result, the possibility that rapid temperature rise is caused lowers, and generation of a rapid exothermic peak is inhibited. It is to be noted that when the firing kiln 20 (the continuous firing kiln) is not used but a firing kiln such as “the shuttle kiln” is used, the first temperature region and the second temperature region may be divided, for example, in accordance with time elapsed from a time when the temperature starts rising from the vicinity of room temperature, a prescribed temperature or the like.

Here, it is necessary to set the maximum value of the second oxygen concentration V2 in a range of 3 to 11 vol % which is smaller than a usual atmospheric oxygen concentration of 21 vol %. That is, when the maximum value of the second oxygen concentration is smaller than 3 vol %, the burning of the organic substances of the organic binder and the like or the unburnt soot (the carbon residue content) of the pore former or the like is not easily performed in the second temperature region 29. In other words, removal of the organic binder and the like requires time in the temperature rise section 24, the firing step of the honeycomb formed body 10 requires a lot of time, and a defect such as deterioration of a manufacturing efficiency or increase of manufacturing cost is caused.

On the other hand, when the maximum value of the second oxygen concentration V2 is larger than 11 vol %, a difference between the maximum value and the usual atmospheric oxygen concentration (about 21 vol %) is not noticeably large, and a difference from the firing under the atmospheric air is not easily made. Therefore, the rapid exothermic peak or the like is easily generated, and cracks are generated. Thus, there is the possibility that effects of the present invention are not sufficiently produced. Therefore, it is especially useful to suppress the maximum value of the second oxygen concentration V2 in the above range.

Here, according to the manufacturing method of the honeycomb structure of the present embodiment, in the first temperature region 28, an upper limit value from room temperature in the vicinity of the inlet 21 is settable to a temperature range of 250° C.±50° C. Specifically, it is known that the above-mentioned organic substances (combustible material) of the organic binder and the like usually burn around 200° C. in the presence of oxygen. Therefore, the upper limit value of the first temperature region 28 is set to a temperature around 250° C., and hence a burning temperature range of the carbon residue content of the rapidly burning pore former or the like is included in the second temperature region 29. As described above, the maximum value of the second oxygen concentration V2 of the second temperature region 29 is set to be smaller than the maximum value of the first oxygen concentration V1 of the first temperature region 28. As a result, it is possible to inhibit the generation of the rapid exothermic peak.

Furthermore, according to the manufacturing method of the honeycomb structure of the present embodiment, the temperature rise process includes the third temperature region 30 connected to the end point 29a of the second temperature region 29. At this time, a maximum value of the third oxygen concentration V3 is adjustable in a range of 3 to 11 vol % which is smaller than the maximum value of the first oxygen concentration V1. Furthermore, as long as the above condition (V1>V3) is satisfied, the maximum value of the third oxygen concentration V3 may be set to the same oxygen concentration as the second oxygen concentration V2 (V2=V3), may be set to be smaller than the second oxygen concentration V2 (V2>V3), or may be set to be larger than the second oxygen concentration V2 (V2<V3). Furthermore, a lower limit value of the third temperature region 30 is set to a temperature range of 400° C.±50° C.

Furthermore, the first oxygen concentration V1 may be set to gradually or stepwisely lower, as the process is close to the second temperature region 29. When the honeycomb formed body 10 is actually fired, the oxygen concentrations of the temperature regions 28 and 29 in the kiln space 23 are not uniform, and the oxygen concentration gradually changes toward an inner portion of the kiln space 23. Therefore, the oxygen concentration in the first temperature region 28 may be adjusted to gradually change or stepwisely change, as the process is close to the second temperature region 29, i.e., as the process is close to the end point 28b of the first temperature region 28.

As described above, according to the manufacturing method of the honeycomb structure of the present embodiment, there are changeable the respective oxygen concentrations of the kiln space of the firing kiln 20 in the temperature rise section 24 in which the temperature of the honeycomb formed body 10 is raised up to the firing temperature, in the firing step of firing the honeycomb formed body 10 (a ceramic formed body). Especially, the organic substances included in the forming material constituting the honeycomb formed body 10 become unburnt around 200° C., and the unburnt carbon residue content starts burning around 300° C. which is defined as a boundary. At the boundary, the maximum value of the second oxygen concentration at 250° C.±50° C. or more in the second temperature region 29 is adjusted to be smaller than the usual atmospheric oxygen concentration, so that the burning reaction or exothermic reaction of the carbon residue content derived from the organic substances can be moderate. As a result, a significant temperature difference between the inside of the honeycomb formed body 10 and the outside thereof is not made.

Consequently, it is possible to inhibit the generation of the cracks during the firing, it is possible to stably fire the honeycomb formed body, and the honeycomb structure having a stabilized product quality is obtainable. Additionally, in the present embodiment, it has been described that the honeycomb structure is manufactured as the ceramic body, but the present invention is not limited to this example, and needless to say, the present invention is also applicable to a case where a ceramic body having a shape other than a honeycomb shape is obtained from a ceramic formed body by firing.

Hereinafter, description will be made as to examples of the manufacturing method of the ceramic body of the present invention, but the manufacturing method of the ceramic body of the present invention is not limited to these examples.

### EXAMPLES

### 1. Honeycomb Formed Body

A forming material (a kneaded material) including cordierite as a main component was prepared at a prescribed blend ratio, and extruded by using a well-known extruder, to obtain a substantially round pillar-shaped honeycomb formed body. Here, in the honeycomb formed body, a partition wall thickness was 8 mil (0.2032 mm), the number of cells per square inch (cpsi) was 300, a honeycomb diameter was 144 mm, and a honeycomb length was 152 mm. Furthermore, a plurality of well-known plugging portions were provided to plug open ends of the cells of the obtained honeycomb formed body in accordance with a predetermined arrangement standard. In other words, the honeycomb formed body was “a plugged honeycomb formed body”.

### 2. Temperature Rise of Honeycomb Formed Body

The obtained honeycomb formed body was fired by using a firing kiln in which a temperature rise process was dividable into a plurality of temperature regions and an oxygen concentration in each temperature region was optionally adjustable. Additionally, in the present example, a continuous firing kiln such as a tunnel kiln or a roller hearth kiln was simulatively reproduced by using an electric kiln in which the same port served as an inlet and an outlet. By use of this electric kiln (the firing kiln), a temperature rise process to reach a firing temperature from the vicinity of room temperature (a temperature rise section: see FIG. 1) is dividable into four temperature regions of a first temperature region, a second temperature region, a third temperature region, and a fourth temperature region (not shown). It is to be noted that the division into the respective temperature regions is optionally adjustable in accordance with time elapsed from the start of temperature rise, and temperatures.

The first temperature region is formed so that the temperature gradually rises from the vicinity of room temperature on the basis of a prescribed temperature rise program, to reach 250° C. Furthermore, the second temperature region is formed so that the temperature gradually rises to an endpoint (300° C.) of the first temperature region, to reach 350° C. Additionally, the third temperature region is formed so that the temperature gradually rises to an endpoint (400° C.) of the second temperature region, to reach 600° C. It is to be noted that the fourth temperature region is adjusted so that the temperature gradually rises from 600° C. up to the firing temperature (e.g., 1400° C.).

### 3. Re: Examples 1 to 8 and Comparative Examples 1 to 6

As described above, the same honeycomb formed body was used, the temperature regions in the firing kiln were set on the same conditions, and then the respective oxygen concentrations (vol %) in the respective temperature regions were changed, thereby firing the honeycomb formed body.

Description will be made as to the respective examples and comparative examples in detail. In each of Examples 1 to 4, the oxygen concentration (a first oxygen concentration) in the first temperature region was set to the same concentration of 21 vol % as under atmospheric pressure, and then a second oxygen concentration in the second temperature region was set to 3 vol %, 5 vol %, 8 vol %, and 11 vol %, thereby performing the firing on the conditions that the second oxygen concentration was lower than the first oxygen concentration (V1>V2). Furthermore, in each of Examples 1 to 4, the firing was performed on the conditions that a third oxygen concentration in the third temperature region was lower than the first oxygen concentration and was the same as the second oxygen concentration (V2=V3).

On one hand, in Examples 5 to 8, first oxygen concentrations in first temperature regions were gradually lowered from 18 vol % down to 8 vol % (Example 5), 7 vol % (Example 6), 10 vol % (Example 7), and 12 vol % (Example 8), respectively. Furthermore, each of the examples satisfied the conditions that a maximum value of a second oxygen concentration was smaller than a maximum value of the first oxygen concentration (V1>V2). Additionally, as to a maximum value of a third oxygen concentration in a third temperature region, Example 5 satisfied the conditions that the maximum value of the third oxygen concentration was smaller than the maximum value of the second oxygen concentration (V2>V3). On the other hand, each of Examples 6 to 8 satisfied the conditions that the maximum value of the third oxygen concentration was larger than the maximum value of the second oxygen concentration (V2<V3).

On the contrary, Comparative Examples 1 to 6 departed from the conditions of the oxygen concentrations in the present invention. In Comparative Example 1, a maximum value of each of oxygen concentrations in a first temperature region, a second temperature region and a third temperature region was set to the same value of 21 vol % as in usual firing conditions under atmospheric air. Furthermore, in each of Comparative Examples 2 and 3, a maximum value of an oxygen concentration in each of a second temperature region and a third temperature region was set to 14 vol % or 18 vol %. Specifically, in the comparative examples, the maximum value of the oxygen concentration in the second temperature region or the like was specified.

On the other hand, in Comparative Example 4, each of maximum values of oxygen concentrations in a first temperature region to a third temperature region was set to 11 vol %. Furthermore, Comparative Example 5 satisfied the conditions that a maximum value of each of a second oxygen concentration and a third oxygen concentration was larger than a maximum value of a first oxygen concentration (V1<V2), whereas in Comparative Example 6, a maximum value of a second oxygen concentration was smaller than a maximum value of a first oxygen concentration, and a maximum value of a third oxygen concentration was the same as the maximum value of the first oxygen concentration.

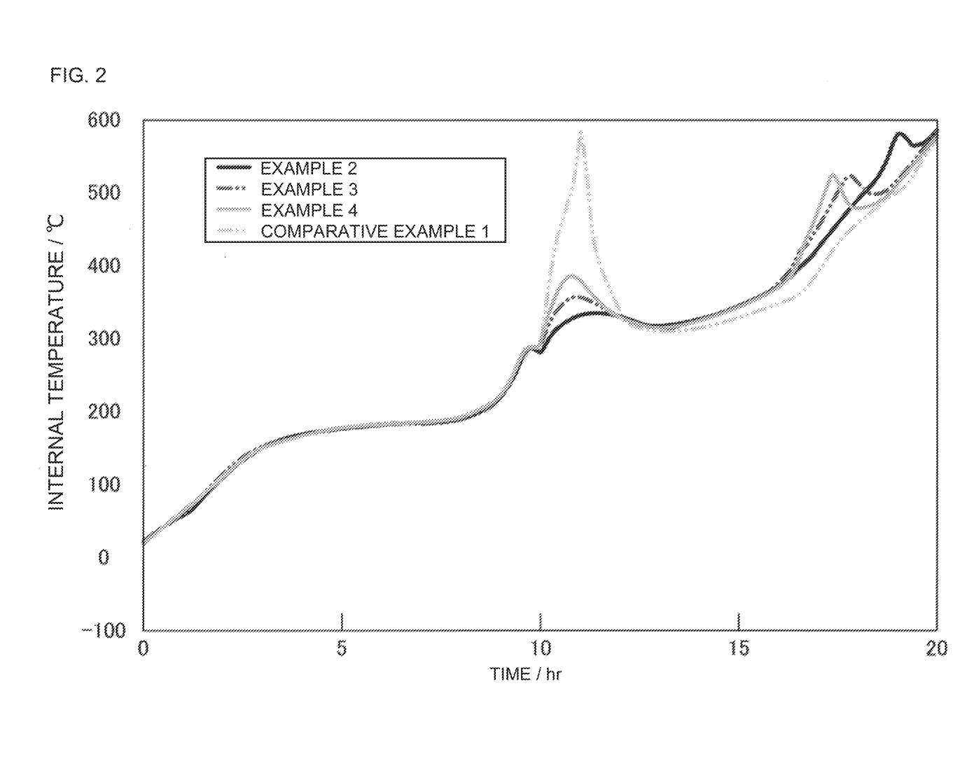

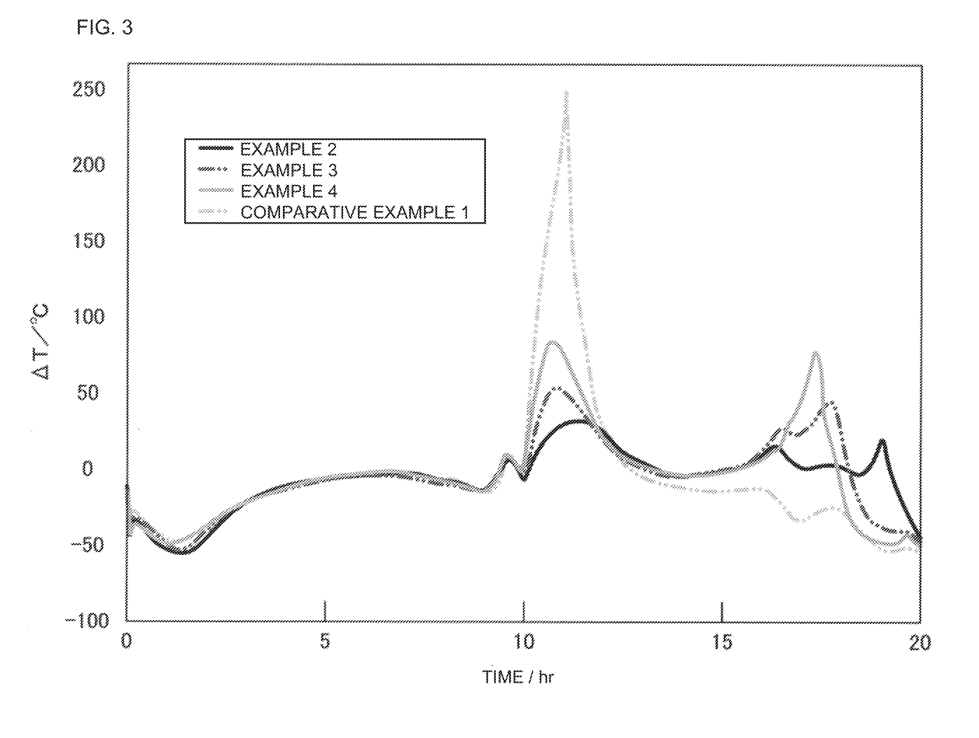

Table 1 mentioned below shows experimental conditions, a difference (ΔT) between an internal temperature of a honeycomb formed body and a kiln temperature at an exothermic peak, a maximum value (vol %) of an oxygen concentration at the exothermic peak, and the evaluation results in each of Examples 1 to 8 and Comparative Examples 1 to 6 mentioned above. Additionally, evaluation was performed by confirming each completely fired honeycomb structure by a visual inspection. When there were not any cracks (firing cuts), the evaluation result was “A”, when it was possible to confirm that micro cracks were present but there were not any appearance problems, the evaluation result was “B”, and when the cracks were present, the evaluation result was “C”. Furthermore, as to Examples 2 and 3 and Comparative Example 1, FIG. 2 is a graph showing a correlation between firing time in a temperature rise section and an internal temperature of a honeycomb formed body, and FIG. 3 is a graph showing a correlation of the firing time in the temperature rise section with a difference (ΔT) between the internal temperature of the honeycomb formed body and a kiln temperature.

TABLE 1

| | | | Second | | | | Exothermic | Oxygen | |
|---|---|---|---|---|---|---|---|---|---|
| | First temperature region | | temperature region | | Third temperature region | | peak ΔT | concentration/ | |
| | | Oxygen | | Oxygen | | Oxygen | (Internal | vol % at | |
| | | concentration/ | Temperature | concentra- | Temperature | concentra- | temp. - kiln | exothermic | Eval- |
| | Temperature range | vol % | range | tion/vol % | range | tion/vol % | temp.) | peak | uation |
| Example 1 | Room temperature | 21 | 300 to 350° C. | 3 | 400 to 600° C. | 3 | 27° C. | 3 | A |
| | to 250° C. | | | | | | | | |
| Example 2 | Room temperature | 21 | 300 to 350° C. | 5 | 400 to 600° C. | 5 | 40° C. | 5 | A |
| | to 250° C. | | | | | | | | |
| Example 3 | Room temperature | 21 | 300 to 350° C. | 8 | 400 to 600° C. | 8 | 63° C. | 8 | A |
| | to 250° C. | | | | | | | | |
| Example 4 | Room temperature | 21 | 300 to 350° C. | 11 | 400 to 600° C. | 11 | 92° C. | 11 | A |
| | to 250° C. | | | | | | | | |
| Example 5 | Room temperature | 18→8 | 300 to 350° C. | 6 to 8 | 400 to 600° C. | 3 to 5 | 94° C. | 7 | A |
| | to 250° C. | | | | | | | | |
| Example 6 | Room temperature | 18→7 | 300 to 350° C. | 5 to 7 | 400 to 600° C. | 8 to 9 | 74° C. | 6 | A |
| | to 250° C. | | | | | | | | |
| Example 7 | Room temperature | 18→10 | 300 to 350° C. | 6 to 7 | 400 to 600° C. | 8 to 9 | 93° C. | 7 | A |
| | to 250° C. | | | | | | | | |
| Example 8 | Room temperature | 18→12 | 300 to 350° C. | 7 to 9 | 400 to 600° C. | 10 to 11 | 117° C. | 9 | B |
| | to 250° C. | | | | | | | | |
| Comparative | Room temperature | 21 | 300 to 350° C. | 21 | 400 to 600° C. | 21 | 267° C. | 21 | C |
| Example 1 | to 250° C. | | | | | | | | |
| Comparative | Room temperature | 21 | 300 to 350° C. | 14 | 400 to 600° C. | 14 | 138° C. | 14 | C |
| Example 2 | to 250° C. | | | | | | | | |
| Comparative | Room temperature | 21 | 300 to 350° C. | 18 | 400 to 600° C. | 18 | 212° C. | 18 | C |
| Example 3 | to 250° C. | | | | | | | | |
| Comparative | Room temperature | 11 | 300 to 350° C. | 11 | 400 to 600° C. | 11 | 137° C. | 11 | C |
| Example 4 | to 250° C. | | | | | | | | |
| Comparative | Room temperature | 5 | 300 to 350° C. | 21 | 400 to 600° C. | 21 | 273° C. | 21 | C |
| Example 5 | to 250° C. | | | | | | | | |
| Comparative | Room temperature | 21 | 300 to 350° C. | 5 | 400 to 600° C. | 21 | 255° C. | 21 | C |
| Example 6 | to 250° C. | | | | | | | | |

### 4. Results and Considerations

### (1) Re: Examples 1 to 4 and Comparative Examples 1 to 3

As shown in Table 1 and FIGS. 2 and 3, even when the maximum value of the first temperature region was the same oxygen concentration as under the atmospheric air, the maximum values of the subsequent second temperature region and third temperature region were set to the oxygen concentration of 11 vol % or less. Consequently, it was possible to minimize the temperature difference ΔT at the exothermic peak, and the suitable evaluations were obtainable. On the other hand, as shown in Comparative Examples 1 to 3, it has been confirmed that the temperature difference ΔT is significantly large on the conditions that the maximum value of the second temperature region is larger than 11 vol %. It has also been confirmed that also when the maximum values of the oxygen concentrations of the second temperature region and the third temperature region indicate the same value of 11 vol %, it is possible to suppress the value of the temperature difference ΔT in Example 4 where the maximum value of the first oxygen concentration is the value under the atmospheric air. This is because a burning range of the carbon residue content of the pore former or the like which rapidly burns in the second temperature region is adjusted so that this burning timing is not superimposed on a burning timing of the organic substances of the binder and the like which burn in the first temperature region, and it has been proved that the higher first oxygen concentration is more suitable. Furthermore, as shown in the results of Comparative Examples 1 to 3, when the oxygen concentration is not changed in the temperature rise process (Comparative Example 1) or when change of the second oxygen concentration to the first oxygen concentration is small (Comparative Examples 2 and 3), any suitable results are not obtainable.

### (2) Re: Examples 5 to 8

As shown in Table 1, even when the maximum value of the oxygen concentration in each of the first temperature region, the second temperature region and the third temperature region is not rapidly changed but is gradually decreased, it is possible to inhibit the generation of the rapid exothermic peak. Therefore, it has been confirmed that the present invention is useful also on the actual manufacturing conditions. In the examples, however, a value (not shown) of the temperature difference ΔT is larger than that of each of Examples 1 to 4. Consequently, it is seen that the first oxygen concentration that is as high as possible (close to the atmospheric air) is more preferable. Furthermore, it is considered that when the value of the temperature difference ΔT is around 100° C., there are not any practical problems.

### (3) Re: Comparative Example 4

A state of a low oxygen concentration was initially kept from the first temperature region of the temperature rise section, but the second oxygen concentration and the third oxygen concentration did not change as compared with the first oxygen concentration. Consequently, a suitable result was not obtainable.

### (4) Re: Comparative Example 5 and Comparative Example 6

It has been confirmed again that when the maximum value of the oxygen concentration in the second temperature region is larger than that in the first temperature region (Comparative Example 5), the effect of the present invention is not obtainable. Furthermore, it has been confirmed that even in a case where the second oxygen concentration is set to be lower than the first oxygen concentration to match the prescribed conditions of the present invention, the suitable result is not obtainable when the third oxygen concentration is not less than the first oxygen concentration again (Comparative Example 6).

As described above, it has been confirmed that the examples (Examples 1 to 8) which satisfy the conditions of the oxygen concentrations prescribed in the manufacturing method of the ceramic body of the present invention are effective, because any cracks are not generated or are hardly generated, and benefits of the range of each oxygen concentration prescribed in the present invention have been recognized.

A manufacturing method of a ceramic body of the present invention is especially usefully usable in a firing step to manufacture a ceramic honeycomb structure for use as a car exhaust gas purifying catalyst carrier or the like.

### DESCRIPTION OF REFERENCE NUMERALS

10: honeycomb formed body (a ceramic formed body), 11a: one end face, 11b: the other end face, 12: shelf plate, 20: firing kiln, 21: inlet, 22: outlet, 23: kiln space, 24: temperature rise section, 25: firing section, 26: honeycomb structure, 27: cooling section, 28: first temperature region, 28a: temperature rise start point, 28b: end point of the first temperature region, 29: second temperature region, 29a: end point of the second temperature region, 30: third temperature region, C: conveyance direction, G: adjusting gas, P: gas supply pipe, V1: first oxygen concentration, V2: second oxygen concentration, and V3: third oxygen concentration.

What is claimed is:

1. A manufacturing method of a ceramic body which comprises a firing step of firing a ceramic formed body in a firing kiln,
wherein in the firing step, a temperature rise process until reaching a firing temperature of the ceramic formed body is divided into a plurality of temperature regions including a first temperature region including a temperature rise start point, a second temperature region having a higher temperature than the first temperature region, and a third temperature region having a higher temperature than the second temperature region,
the manufacturing method of the ceramic body further comprising an oxygen concentration adjustment step of adjusting a first oxygen concentration in the first temperature region in a range of 7 to 21 vol %, adjusting a maximum value of a second oxygen concentration in the second temperature region in a range of 3 to 11 vol % which is smaller than a maximum value of the first oxygen concentration, and adjusting a maximum value of a third oxygen concentration in the third temperature region in a range of 3 to 11 vol % which is smaller than the maximum value of the first oxygen concentration.

2. The manufacturing method of the ceramic body according to claim 1,
wherein as the firing kiln,
a continuous firing kiln is used which has an inlet and an outlet and is configured to fire the ceramic formed body while conveying the ceramic formed body in a kiln space between the inlet and the outlet,
the first temperature region includes the inlet as the temperature rise start point,
the second temperature region is positioned on a downstream side of the conveyance of the ceramic formed body from the first temperature region, and
the third temperature region is positioned on the downstream side of the conveyance of the ceramic formed body from the second temperature region.

3. The manufacturing method of the ceramic body according to claim 1,
wherein in the oxygen concentration adjustment step, a minimum value of the first oxygen concentration is adjusted to 8 vol % or more and the maximum value of the second oxygen concentration is adjusted to 8 vol % or less.

4. The manufacturing method of the ceramic body according to claim 1,
wherein in the oxygen concentration adjustment step, the maximum value of the third oxygen concentration is adjusted in a range of 6 to 10 vol %.

5. The manufacturing method of the ceramic body according to claim 1,
wherein an upper limit value of the first temperature region is adjusted to a temperature range of 250° C.±50° C.

6. The manufacturing method of the ceramic body according to claim 1,
wherein in the oxygen concentration adjustment step, the maximum value of the third oxygen concentration in the third temperature region is adjusted to be smaller than the maximum value of the second oxygen concentration, and
a lower limit value of the third temperature region is adjusted to a temperature range of 400° C.±50° C.

7. The manufacturing method of the ceramic body according to claim 1,
wherein in the oxygen concentration adjustment step, the maximum value of the third oxygen concentration in the third temperature region is adjusted to be larger than the maximum value of the second oxygen concentration, and
a lower limit value of the third temperature region is adjusted to a temperature range of 400° C.±50° C.

8. The manufacturing method of the ceramic body according to claim 1,
wherein in the oxygen concentration adjustment step, the first oxygen concentration is adjusted to gradually or stepwisely lower, as the process is close to the second temperature region.

9. The manufacturing method of the ceramic body according to claim 1,
wherein the ceramic body is a honeycomb structure.
